(19) United States
(12) Patent Application Publication
(10) Pub. No.: US 2012/0041745 A1
(43) Pub. Date: Feb. 16, 2012

(54) PLAYBACK PIPELINE FOR TESTING WIRELESS DEVICES

(76) Inventor: Jeremy Spilman, Santa Clara, CA (US)

(21) Appl. No.: 13/214,416

(22) Filed: Aug. 22, 2011

Related U.S. Application Data
(63) Continuation-in-part of application No. 12/505,634, filed on Jul. 20, 2009.

(51) Int. Cl. G06G 7/62

(52) U.S. Cl. 703/13

(57) ABSTRACT

Evaluation of a wireless device using a channel emulator is facilitated by validating a playback file; compensating for external loss; applying post processing changes; compiling the playback file; streaming playback file data to a channel emulator; and performing playback by the channel emulator. Validation is performed by operating directly on the user's editable playback file so that compilation of the playback file is not required for validation. User-supplied values indicative of the levels of external losses are used to automatically adjust the corresponding values in the playback file by the specified amount before the playback data is relayed to the channel emulator. Post processing changes indicative of alternate channel conditions may be used to augment or replace values in the playback file before the playback data is relayed to the channel emulator. The playback file is sequentially compiled as playback data is used by the channel emulator to allow playback to start sooner. Real-time streaming of playback data also allows an unlimited number of playback instructions to be processed within a fixed memory footprint. A power tracking loop detect changes in the transmit power level of a connected device during playback, and the channel emulator is automatically recalibrated to account for power level changes.

### CROSS-REFERENCE TO RELATED APPLICATIONS

This application is a continuation-in-part of U.S. patent application Ser. No. 12/505,634, titled CONFIGURING A SIMULATOR FOR TESTING WIRELESS DEVICES, filed Jul. 20, 2009, which is incorporated by reference.

### FIELD OF THE INVENTION

This invention is generally related to test equipment, and more particularly to test equipment for evaluating wireless devices.

### BACKGROUND OF THE INVENTION

Cellular networks and Wireless Local Area Networks (“WLANs”) enable communications between mobile wireless devices such as mobile phones and portable computers and fixed location wireless devices such as access points and base stations. It is naturally desirable to test the performance of such devices under different conditions. However, testing wireless devices in an open environment is notoriously difficult because wireless communications can be affected by ambient sources of interference. It is now relatively common to use simulators to perform wireless device testing in a closed environment. One type of simulator includes a separate container for each wireless device to shield against external electromagnetic interference (EMI). Communications are converted from wireless radio frequency (RF) to wired signals, and the containers are placed in communication via wired connections. A channel emulator connected between the containers subjects the communications to simulated physical environmental effects. The communication link between each two devices is called a “channel,” and the simulated physical environmental effects created by the channel emulator are called the “channel conditions.” Channel conditions are described by “channel models,” each of which includes a single set of parameters which describe the statistical characteristics of the channel conditions. The process whereby the channel emulator recreates the statistical properties of the channel model on the channel between the two devices is known as “playing” the channel model.

A typical playback test pipeline of operations is illustrated in FIG. 1. A playback file provided by the user is compiled 100 and then loaded onto the channel emulator 102. The compilation process verifies the values contained within the playback file are valid, and generates a new compiled playback file which is ready to be loaded onto the channel emulator. The channel emulator is then calibrated 104 in order to accurately receive the RF signals transmitted from one connected device, and in turn apply the desired channel conditions to those signals before retransmitting those signals to a second connected device. Typically this input power calibration involves ‘leveling’ the power setting on all RF inputs of the channel emulator. After this calibration is performed, any signal input to the channel emulator at the same power that was measured during the ‘leveling’ process will be output from the channel emulator at the desired power level specified in the playback file. If the transmit power level of a connected device changes from the calibrated level, the output power from the channel emulator will be offset from the desired power level specified in the playback file by the amount of the change. This introduces a ‘tracking error’ which can typically only be corrected by stopping the test and performing a new calibration. Once the playback file is compiled it can be loaded onto the channel emulator for playback. Typically the channel emulator must have enough free space in memory or local disk storage inside the channel emulator device to hold the entire playback file. Consequently, the maximum size of the playback file will be limited to the amount of memory/storage space locally on the channel emulator. After the entire file has been loaded onto the channel emulator it will start playing back the file 106, thereby generating the channel conditions.

### SUMMARY OF THE INVENTION

According to an aspect of the invention, a computer program product comprises a non-transitory computer usable medium having a computer readable program code embodied therein, said computer readable program code executed to implement a method for evaluating a device under test comprising the steps of: validating a playback file; compensating for external loss; compiling the playback file; streaming playback file data to a channel emulator; and performing playback by the channel emulator.

According to another aspect of the invention, apparatus for evaluating a device under test comprises: a playback file generator including a processor and non-transitory computer usable medium having a computer readable program code embodied therein, said computer readable program code validating a playback file, compensating for external loss, compiling the playback file, and streaming playback file data; and a channel emulator which simulates channel conditions for the device under test in response to the streamed playback file data.

According to another aspect of the invention, a method for evaluating a device under test comprises the steps of: using a playback file generator including a non-transitory computer usable medium having a computer readable program code embodied therein, validating a playback file, compensating for external loss, compiling the playback file, and streaming playback file data; and simulating channel conditions for the device under test in response to the streamed playback file data using a channel emulator.

An advantage of at least one embodiment of the invention is enhanced playback file validation and error correction. Validation is performed by operating directly on the user's editable playback file. The user is then informed of any syntax or range errors in the playback file. Any required corrections can be made more quickly and easily than was previously possible because no compilation of the playback file is required for validation.

Another advantage of at least one embodiment of the invention is enhanced external loss compensation. Typical prior art systems do not provide any facility to compensate for external losses so external loss compensation has been done manually by the user. For example, the user would edit the playback file and adjust each value within the file by the necessary amount. Whenever external losses change, and for each separate channel emulator on which the test is to be run, the user must create a new playback file and manually re-adjust the values within the file to compensate for the new external losses. This is both time consuming and error prone. In accordance with an embodiment of the invention the user inputs values indicative of the levels of external losses separately from the playback file. The specified values are stored in non-transient memory and provided as inputs to a just-in-time compilation module. The just-in-time compilation module automatically adjusts the corresponding values in the playback file by the specified amount before the playback data is relayed to the channel emulator.

Another advantage of at least one embodiment of the invention is the ability to apply post processing changes to the playback file. Typical prior art systems do not provide any facility to add or replace data in the file other than editing the file manually. At least one embodiment of the invention allows the user to specify parameters that can replace or augment playback data from the original playback file. These parameters can include but are not limited to Doppler rate, noise power density, power delay profile, spatial correlation output power, and other channel conditions. The specified values are stored in non-transient memory and provided as inputs to a just-in-time compilation module. This allows the user to quickly adjust a playback file without requiring the steps of editing and revalidating the original playback file. Furthermore, this also allows the user to conduct several different tests using the same starting playback file.

Another advantage of at least one embodiment of the invention is just-in-time compilation. Typical prior art systems compile the entire playback file before starting playback. In contrast, at least one embodiment of the invention compiles the playback file sequentially as the data is consumed by the channel emulator. The playback file's data can be adjusted dynamically by the external loss compensation and post processing data. Further, the user-editable playback file is compiled into a more efficient binary representation of the data in order to reduce the amount of data which must be transferred to the channel emulator. This simplifies the channel emulator logic required to parse the playback file and advantageously allows for playback to start sooner, particularly for larger playback files.

Another advantage of at least one embodiment of the invention is real-time streaming of playback instructions. Typical prior art systems store-and-play the entire set of playback instructions within local memory of the channel emulator, which means the memory requirement to store the set of playback instructions increases linearly with the number of playback instructions. Real-time streaming allows an unlimited number of playback instructions to be processed within a fixed memory footprint. Further, the real-time streaming architecture allows playback to start more quickly because playback can begin as soon as the first instruction is received by the channel emulator.

Another advantage of at least one embodiment of the invention is input power tracking. Typical prior art systems suffer from “tracking error” due to changes in the transmit power of devices connected to the channel emulator after the initial input power calibration process is completed. At least one embodiment of the invention includes a power tracking loop which runs continuously during playback to detect changes in the transmit power level of a connected device. The invention applies a control law to determine when the emulator must be adjusted. For instance, in a control law based on a step size, it could be determined that if the measured power has changed by a step size from the last measurement, the emulator must be adjusted to meet the new power. Further, the channel emulator is automatically adjusted to account for an increase or decrease in the transmit power of the connected device. This allows the power levels specified in the playback file to be more accurately produced by the channel emulator regardless of large or small changes in the connected devices transmit power over time.

Other aspects, features and advantages of embodiments of the invention will be apparent from the figures and detailed description.

### BRIEF DESCRIPTION OF THE FIGURES

FIG. 1 illustrates a typical prior art playback test pipeline.

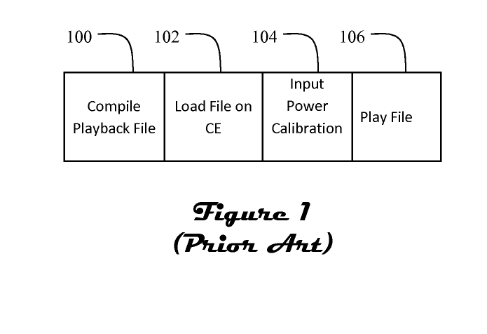

FIG. 2 is a block diagram of a wireless network simulator.

FIG. 3 illustrates an improved playback test pipeline.

FIG. 4 illustrates playback file validation.

FIG. 5 illustrates external loss compensation and post processing data storage.

FIG. 6 illustrates just-in-time compilation.

FIG. 7 illustrates real-time streaming.

FIG. 8 illustrates the input power tracking algorithm.

### DETAILED DESCRIPTION

Various aspects of the invention may be implemented by computer program code that is stored in non-transitory memory. The computer program code may be used by processing hardware to accomplish steps and functions such as those described below to facilitate evaluating wireless devices.

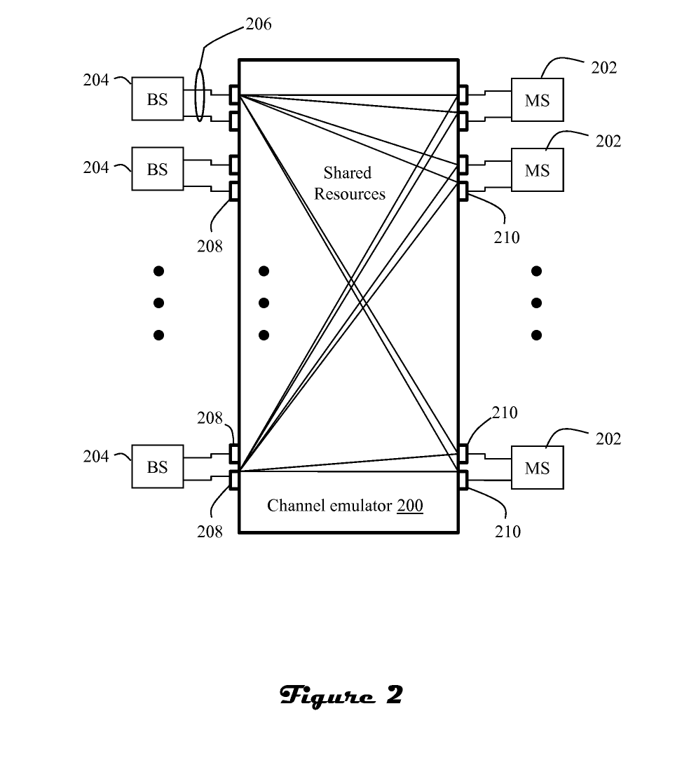

FIG. 2 illustrates a channel emulator 200. The channel emulator is operable to interconnect a set of two or more wireless devices in order to simulate effects on communications between the devices by using various shared resources. The wireless devices may include, without limitation, mobile stations 202 such as wireless phones and portable computers, and base stations 204 such as access points and cellular base stations. The wireless devices are disposed in first and second housings, respectively, which provide shielding from external electromagnetic interference (EMI). External cabling 206 is employed by the user in place of the antennas to connect the wireless devices to ports on the channel emulator. In the illustrated example, each port 208 is associated with a particular antenna port of the base station 204 to which it is connected by a cable, and each port 210 is associated with a particular antenna port of the mobile station 202 to which it is connected by a cable. The signals transmitted between devices are selectively modified by the channel emulator in order to simulate effects such as multipath reflections, delay spread, angle of arrival, power angular spread, angle of departure, antenna spacing, uniform linear array for both TX and RX side, Doppler due to fluorescent light effects, Doppler from moving vehicle, Doppler from changing environments, path loss, shadow fading effects, reflections in clusters and external interference such as radar signals, microwave oven emissions, phone transmission and other wireless signals or noise.

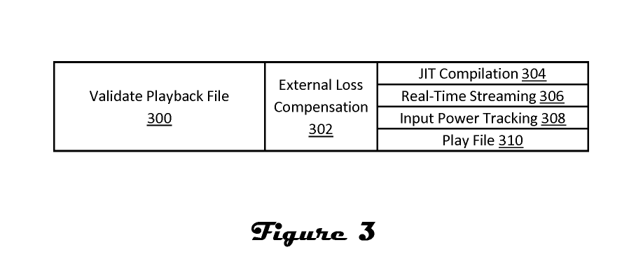

FIG. 3 illustrates an improved playback test pipeline for use with the channel emulator of FIG. 2 or other suitable channel emulators. The pipeline includes functions associated with the transfer of data to the channel emulator from the supermodel configuration interface described in the parent application. Aspects of the playback test pipeline may be implemented using computer program code which is stored in non-transient computer-readable memory and utilized by a microprocessor to implement one or more steps or sub-steps. An initial step 300 in the pipeline is to validate the playback file. The next step 302 is external loss compensation. External loss compensation is followed by just-in-time compilation 304, Real-time streaming 306, input power tracking 308, and playing the file 310. These steps are described in greater detail below.

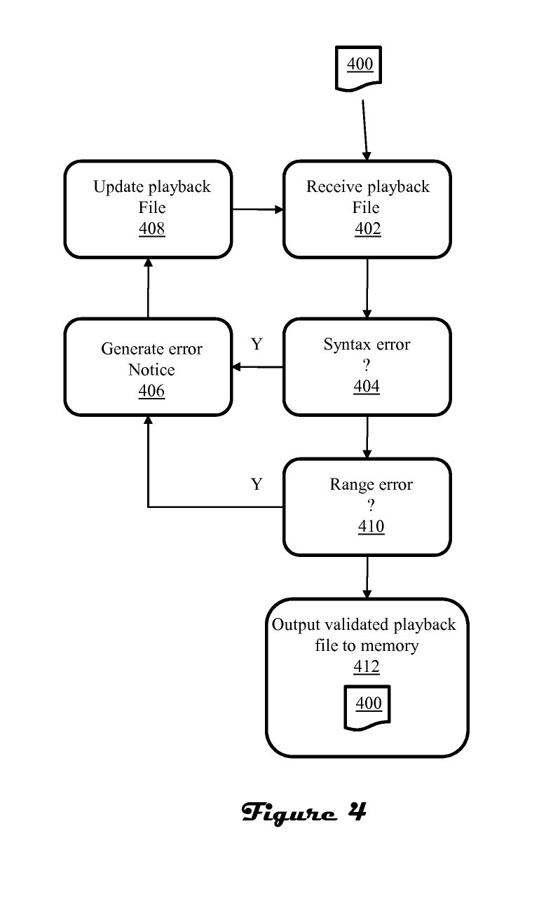

FIG. 4 illustrates playback file validation 300 (FIG. 3) in greater detail. The validation step is an initial step which is implemented at the beginning of the playback process to inform the user of any syntax or range errors in their playback file. After a playback file 400 is received at step 402 it is checked for syntax errors at step 404. If any syntax errors are found then an error notice is generated at step 406 and provided to the user to prompt update of the playback file at step 408 and rechecking for syntax errors 404. When no syntax errors are found the playback file is checked for range errors in step 410. Validation is performed directly on the user's playback file. If any range errors are found then an error notice is generated 406 and provided to the user to prompt update 408 of the playback file and rechecking for range errors. When no range errors are found the validated playback file 401 is outputted to memory in step 412. External loss compensation 302 (FIG. 3) is initiated after validation is complete. Checking is performed directly on the user's playback file. Advantageously, no compilation is required.

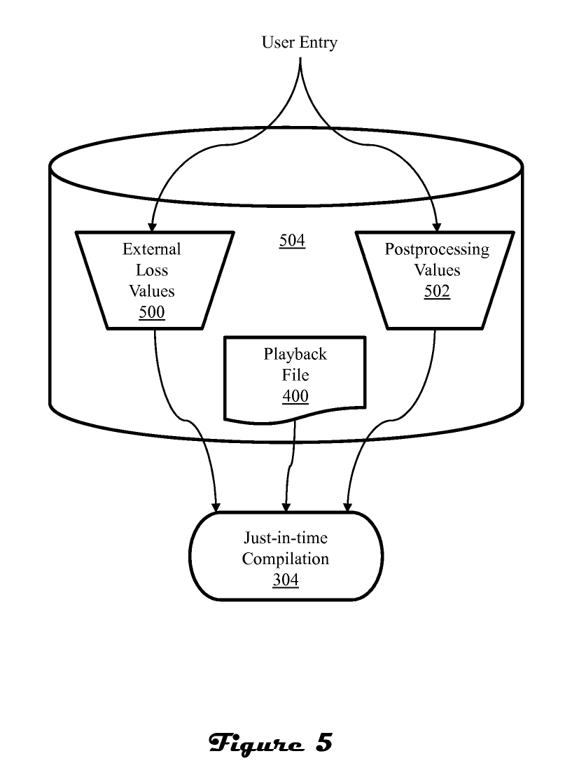

FIG. 5 illustrates external loss compensation 302 (FIG. 3) and post processing data storage in greater detail. RF devices are connected to a channel emulator through conductive cabling, and RF components such as splitters, combiners, duplexers, isolators, and circulators may be used to achieve desired network connectivity. These cables and other RF components attenuate the signal and can introduce significant unwanted “external losses” between the two or more devices which are being connected. In accordance with an embodiment of the invention the user inputs values 500 indicative of the level of external losses separately from the playback file 400. In accordance with another embodiment of the invention, the user is able to specify post processing values 502 that can augment or replace existing playback file values. Both sets of values and the playback file are stored in non-transient memory 504 and provided as inputs to a module which performs just-in-time compilation 304. Just-in-time compilation adjusts the corresponding values in the playback file by the specified amount before the playback data is relayed to the channel emulator.

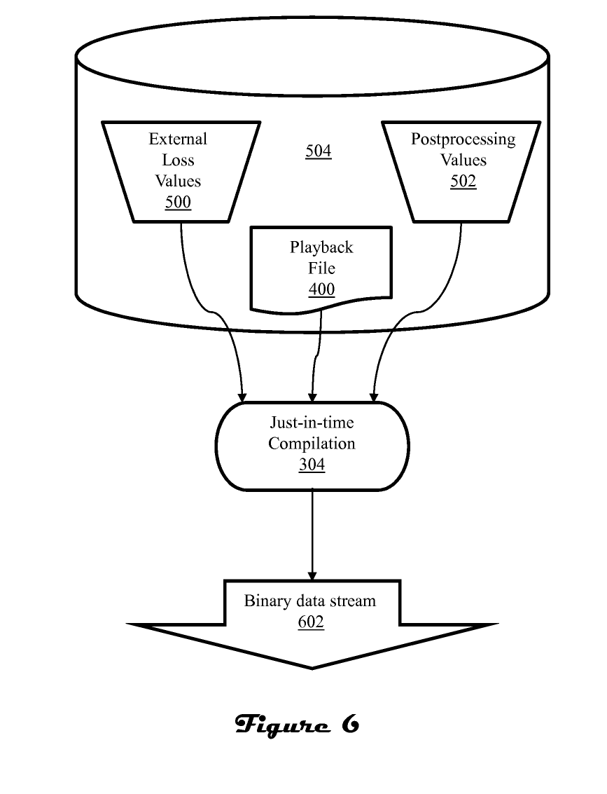

FIG. 6 illustrates just-in-time compilation 304 in greater detail. Just-in-time compilation includes adjustment of the playback file 400 based on the external loss values 500 and postprocessing values 502. External Loss is the loss between the ACE and the UE, which is measured by the user. Compensating for external loss may be considered a subset of post processing changes because the data is being changed. In the case of compensating for external loss this can include measuring the external loss, calculating it based on the difference between desired/actual output power, and then applying it. However, post-processing changes can include new data that was not included in the original playback file. The adjusted user-editable playback file 400 is compiled into a more efficient binary representation of the data in order to reduce the amount of data which must be transferred to the channel emulator. This also simplifies the channel emulator logic required to parse the playback file. While existing systems compile the entire playback file before starting playback, just-in-time compilation compiles the playback file sequentially as the data is consumed by the channel emulator. This advantageously allows for playback to start sooner, particularly for larger playback files. The result is binary data stream 602.

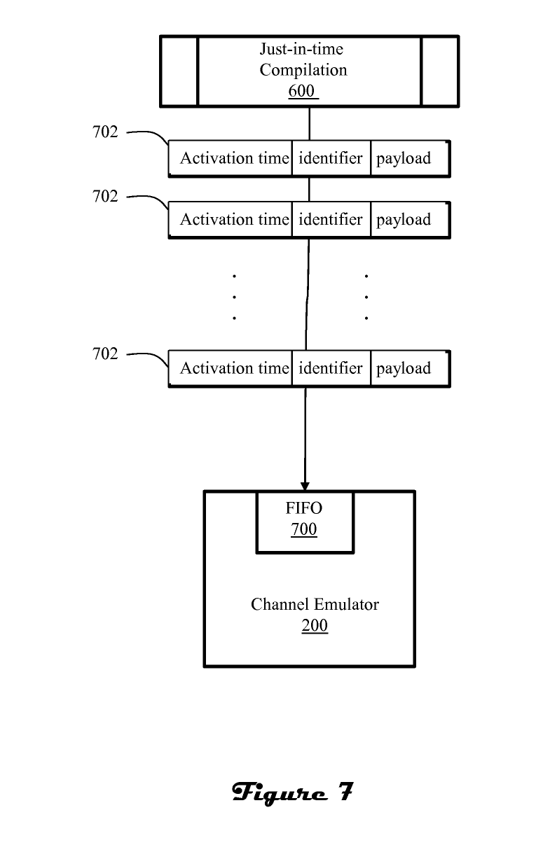

FIG. 7 illustrates real-time streaming 306 (FIG. 3) in greater detail. Player software operated by the user may reside on the same or a physically distinct device as the channel emulator 200. When the user specifies that playback should begin, the playback software begins streaming playback data onto the channel emulator. The channel emulator maintains a FIFO buffer 700 of playback data which is received from the player software. Playback data is compiled by the just-in-time compilation 600 into a binary data stream of instructions 702 which include (1) an activation time when the instruction should be executed, (2) an identifier specifying the type of action which should be taken by the channel emulator, and (3) action specific payload. The channel emulator can begin playback as soon as at least one playback instruction is present in the FIFO buffer, and continues playback indefinitely until either (1) a playback instruction is received whose activation time is prior to the current run-time, or (2) a playback instruction is received which indicates playback should stop.

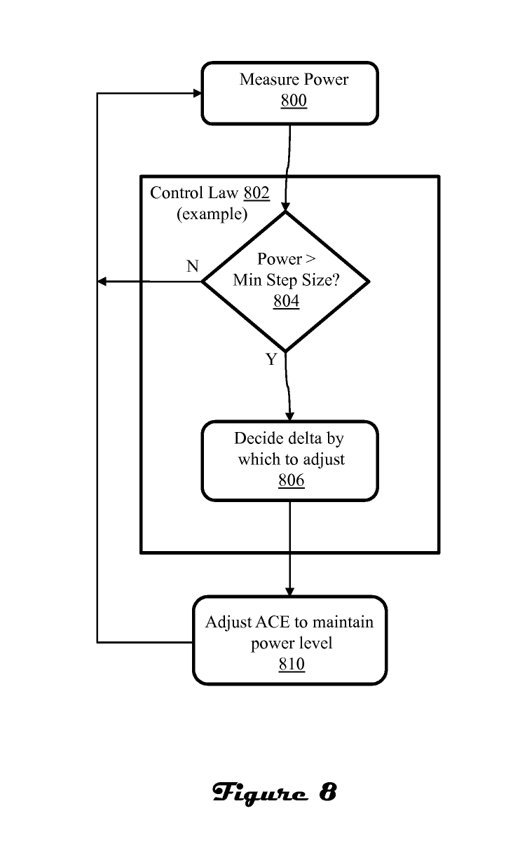

FIG. 8 illustrates input power tracking 308 (FIG. 3) in greater detail. A power tracking loop runs continuously during playback 310 (FIG. 3) and responds to changes in the transmit power level of a connected device. More particularly, the power tracking loop adjusts the channel emulator to account for unplanned changes (an increase or decrease) in the connected device's transmit power in order to maintain a currently desired power level. This allows the power levels specified in the playback file 400 (FIG. 6) to be more accurately produced by the channel emulator regardless of large or small unplanned changes in the connected devices transmit power over time. Transmit power of the connected device is measured in step 800. A control law 802 is used to determine when and how much to adjust the power levels based on the measured power. The illustrated control law is a non-limiting example in which the power level is not adjusted if measured power change from a previous measurement (e.g., most recent measurement) is not greater than a minimum step size as indicated in step 804. If measured power change is greater than the minimum step size then the control law decides a delta by which to adjust power as indicated by step 806. The channel emulator is then adjusted to maintain power level as indicated by step 810.

While the invention is described through the above exemplary embodiments, it will be understood by those of ordinary skill in the art that modifications and variations may be made without departing from the inventive concepts. Further, while the embodiments are described in connection with various illustrative structures, one skilled in the art will recognize that the system may be embodied in connection with other structures. Accordingly, the invention should not be viewed as limited except by the scope and spirit of the appended claims.

What is claimed is:

1. A computer program product comprising a non-transitory computer usable medium having a computer readable program code embodied therein, said computer readable program code executed to implement a method for evaluating a device under test comprising the steps of:
validating a playback file;
compensating for external loss;
apply post-processing changes;
compiling the playback file; and
streaming playback file data to a channel emulator.

2. The computer program product of claim 1 wherein validating the playback file includes providing an indication of any detected syntax or range errors.

3. The computer program product of claim 1 wherein the playback file is not compiled, and including validating the playback file by checking the playback file for errors.

4. The computer program product of claim 1 wherein compensating for external loss includes receiving and storing values indicative of the level of external losses.

5. The computer program product of claim 4 wherein compiling the playback file is performed sequentially as file data is used by the channel emulator.

6. The computer program product of claim 5 wherein compiling the playback file includes generating instructions which include an activation time when the instruction should be executed.

7. The computer program product of claim 6 wherein compiling the playback file includes generating instructions which include an identifier specifying a type of action which should be taken by the channel emulator.

8. The computer program product of claim 7 wherein compiling the playback file includes generating instructions which include an action specific payload.

9. The computer program product of claim 1 wherein the channel emulator inputs received playback file data to a FIFO buffer, and including the channel emulator beginning playback before all playback file data is received.

10. The computer program product of claim 7 including continuing playback until either a playback instruction is received with an activation time prior to current run-time, or a playback instruction is received which indicates playback should stop.

11. The computer program product of claim 1 including detecting changes in transmit power level of a connected device during playback.

12. The computer program product of claim 11 including calibrating the channel emulator to account for changes in the connected device's transmit power.

13. Apparatus for evaluating a device under test comprising:
a playback file generator including a processor and non-transitory computer usable medium having a computer readable program code embodied therein, said computer readable program code validating a playback file, compensating for external loss, compiling the playback file, and streaming playback file data; and
a channel emulator which simulates channel conditions for the device under test in response to the streamed playback file data.

14. The apparatus of claim 13 wherein the playback file generator validates the playback file and provides an indication of any detected syntax or range errors.

15. The apparatus of claim 13 wherein the playback file is not compiled, and wherein the playback file generator validates the playback file by checking the playback file for errors.

16. The apparatus of claim 13 wherein the playback file generator receives and stores values indicative of the level of external losses.

17. The apparatus of claim 16 wherein the playback file generator sequentially compiles the playback file as file data is used by the channel emulator.

18. The apparatus of claim 17 wherein the playback file generator generates instructions which include an activation time when the instruction should be executed.

19. The apparatus of claim 18 wherein the playback file generator generates instructions which include an identifier specifying a type of action which should be taken by the channel emulator.

20. The apparatus of claim 19 wherein the playback file generator generates instructions which include an action specific payload.

21. The apparatus of claim 13 wherein the channel emulator inputs received playback file data to a FIFO buffer, and including the channel emulator beginning playback before all playback file data is received.

22. The apparatus of claim 19 wherein the playback file generator continues playback until either a playback instruction is received with an activation time prior to current run-time, or a playback instruction is received which indicates playback should stop.

23. The apparatus of claim 13 wherein the playback file generator detects changes in transmit power level of a connected device during playback.

24. The apparatus of claim 23 wherein the playback file generator calibrates the channel emulator to account for changes in the connected device's transmit power.

25. A method for evaluating a device under test comprising the steps of:
using a playback file generator including a non-transitory computer usable medium having a computer readable program code embodied therein, validating a playback file, compensating for external loss, compiling the playback file, and streaming playback file data; and
simulating channel conditions for the device under test in response to the streamed playback file data using a channel emulator.

26. The method of claim 25 wherein validating the playback file includes providing an indication of any detected syntax or range errors.

27. The method of claim 25 wherein the playback file is not compiled, and including validating the playback file by checking the playback file for errors.

28. method of claim 25 wherein compensating for external loss includes receiving and storing values indicative of the level of external losses.

29. The method of claim 28 including performing compiling of the playback file sequentially as file data is used by the channel emulator.

30. The method of claim 29 wherein compiling the playback file includes generating instructions which include an activation time when the instruction should be executed.

31. The method of claim 30 wherein compiling the playback file includes generating instructions which include an identifier specifying a type of action which should be taken by the channel emulator.

32. The method of claim 31 wherein compiling the playback file includes generating instructions which include an action specific payload.

33. The method of claim 25 wherein the channel emulator inputs received playback file data to a FIFO buffer, and including the channel emulator beginning playback before all playback file data is received.

34. The method of claim 31 including continuing playback until either a playback instruction is received with an activation time prior to current run-time, or a playback instruction is received which indicates playback should stop.

35. The method of claim 25 including detecting changes in transmit power level of a connected device during playback.

36. The method of claim 35 including calibrating the channel emulator to account for changes in the connected device's transmit power.

37. A computer program product comprising a non-transitory computer usable medium having a computer readable program code embodied therein, said computer readable program code executed to implement a method for evaluating a device under test comprising the steps of:
validating an uncompiled playback file; and
providing an indication of detected errors.

38. The computer program product of claim 38 including providing an indication of any detected syntax or range errors.

39. A computer program product comprising a non-transitory computer usable medium having a computer readable program code embodied therein, said computer readable program code executed to implement a method for evaluating a device under test comprising the steps of:
receiving an indication of changes in external loss associated with a connected device during playback; and
compensating for the external loss.

40. The computer program product of claim 39 wherein compensating for external loss includes receiving and storing values indicative of the level of external losses.

41. The computer program product of claim 39 including detecting changes in transmit power level of the connected device during playback.

42. The computer program product of claim 41 including calibrating a channel emulator to account for changes in the connected device's transmit power.

43. A computer program product comprising a non-transitory computer usable medium having a computer readable program code embodied therein, said computer readable program code executed to implement a method for evaluating a device under test comprising the steps of:
receiving a playback file; and
compiling the playback file sequentially as file data is used by a channel emulator.

44. The computer program product of claim 43 wherein compiling the playback file includes generating instructions which include an activation time when the instruction should be executed.

45. The computer program product of claim 44 wherein compiling the playback file includes generating instructions which include an identifier specifying a type of action which should be taken by the channel emulator.

46. The computer program product of claim 45 wherein compiling the playback file includes generating instructions which include an action specific payload.

47. A computer program product comprising a non-transitory computer usable medium having a computer readable program code embodied therein, said computer readable program code executed to implement a method for evaluating a device under test comprising the steps of:
streaming playback file data to a channel emulator; and
utilizing the streamed playback file data by the channel emulator to perform a test such that only a portion of playback file data is stored by the channel emulator during the test.

48. The computer program product of claim 47 wherein the channel emulator inputs received playback file data to a FIFO buffer, and including the channel emulator beginning playback before all playback file data is received.

49. The computer program product of claim 48 including continuing playback until either a playback instruction is received with an activation time prior to current run-time, or a playback instruction is received which indicates playback should stop.

50. Apparatus for evaluating a device under test comprising:
a playback file generator including a processor and non-transitory computer usable medium having a computer readable program code embodied therein, said computer readable program code validating an uncompiled playback file and providing an indication of detected errors; and
a channel emulator which simulates channel conditions for the device under test in response to a validated playback file data.

51. The apparatus of claim 50 wherein the playback file generator validates the playback file and provides an indication of any detected syntax or range errors.

52. Apparatus for evaluating a device under test comprising:
a playback file generator including a processor and non-transitory computer usable medium having a computer readable program code embodied therein, said computer readable program code detecting changes in external loss associated with the device under test during playback and compensating for the external loss; and
a channel emulator which simulates channel conditions for the device under test in response to playback file data.

53. The apparatus of claim 52 wherein the playback file generator receives and stores values indicative of the level of external losses.

54. The apparatus of claim 52 wherein the playback file generator detects changes in transmit power level of the device during playback.

55. The apparatus of claim 54 wherein the playback file generator calibrates the channel emulator to account for changes in the device's transmit power.

56. Apparatus for evaluating a device under test comprising:
a playback file generator including a processor and non-transitory computer usable medium having a computer readable program code embodied therein, said computer readable program code receiving a playback file and compiling the playback file sequentially as file data is used by a channel emulator; and
a channel emulator which simulates channel conditions for the device under test in response to playback file data.

57. The apparatus of claim 56 wherein the playback file generator sequentially compiles the playback file as file data is used by the channel emulator.

58. The apparatus of claim 57 wherein the playback file generator generates instructions which include an activation time when the instruction should be executed.

59. The apparatus of claim 58 wherein the playback file generator generates instructions which include an identifier specifying a type of action which should be taken by the channel emulator.

60. The apparatus of claim 59 wherein the playback file generator generates instructions which include an action specific payload.

61. Apparatus for evaluating a device under test comprising:
a playback file generator including a processor and non-transitory computer usable medium having a computer readable program code embodied therein, said computer readable program code streaming playback file data; and
a channel emulator which receives the streamed playback file data and utilizes the streamed playback file data to simulate channel conditions for the device under test such that only a portion of playback file data is stored by the channel emulator during the simulation.

62. The apparatus of claim 61 wherein the channel emulator inputs received playback file data to a FIFO buffer, and including the channel emulator beginning playback before all playback file data is received.

63. The apparatus of claim 61 wherein the playback file generator continues playback until either a playback instruction is received with an activation time prior to current run-time, or a playback instruction is received which indicates playback should stop.

64. A method for evaluating a device under test comprising the steps of:
using a playback file generator including a non-transitory computer usable medium having a computer readable program code embodied therein, validating an uncompiled playback file and providing an indication of detected errors; and
simulating channel conditions for the device under test in response to playback file data using a channel emulator.

65. The method of claim 64 including providing an indication of any detected syntax or range errors.

66. A method for evaluating a device under test comprising the steps of:
using a playback file generator including a non-transitory computer usable medium having a computer readable program code embodied therein, detecting changes in external loss associated with the device during playback and compensating for the external loss; and
simulating channel conditions for the device under test in response to playback file data using a channel emulator.

67. The method of claim 66 wherein compensating for external loss includes receiving and storing values indicative of the level of external losses.

68. The method of claim 66 including detecting changes in transmit power level of the connected device during playback.

69. The method of claim 68 including calibrating a channel emulator to account for changes in the device's transmit power.

70. A method for evaluating a device under test comprising the steps of:
using a playback file generator including a non-transitory computer usable medium having a computer readable program code embodied therein, receiving a playback file, and
compiling the playback file sequentially as file data is used by a channel emulator; and
simulating channel conditions for the device under test in response to playback file data using a channel emulator.

71. The method of claim 70 wherein compiling the playback file includes generating instructions which include an activation time when the instruction should be executed.

72. The method of claim 71 wherein compiling the playback file includes generating instructions which include an identifier specifying a type of action which should be taken by the channel emulator.

73. The method of claim 72 wherein compiling the playback file includes generating instructions which include an action specific payload.

74. A method for evaluating a device under test comprising the steps of:
using a playback file generator including a non-transitory computer usable medium having a computer readable program code embodied therein, streaming playback file data to a channel emulator, and utilizing the streamed playback file data by the channel emulator to perform a test such that only a portion of playback file data is stored by the channel emulator during the test; and
simulating channel conditions for the device under test in response to playback file data using a channel emulator.

75. The method of claim 74 wherein the channel emulator inputs received playback file data to a FIFO buffer, and including the channel emulator beginning playback before all playback file data is received.

76. The method of claim 74 including continuing playback until either a playback instruction is received with an activation time prior to current run-time, or a playback instruction is received which indicates playback should stop.

77. A method for evaluating a device under test comprising the steps of:
receiving a playback file; and
applying post processing changes to channel conditions as specified by an external source by updating data contained in the playback file.

78. A computer program product comprising a non-transitory computer usable medium having a computer readable program code embodied therein, said computer readable program code executed to implement a method for evaluating a device under test comprising the steps of:
receiving a playback file; and
applying post processing changes to channel conditions as specified by an external source by updating data contained in the playback file.
